(19) United States
(12) Patent Application Publication
(10) Pub. No.: US 2017/0071164 A1
(43) Pub. Date: Mar. 16, 2017

(54) INSECT SINGULATING DEVICE

(71) Applicant: Flysorter, LLC, Seattle, WA (US)

(72) Inventors: David S. Zucker, Seattle, WA (US); Matthew A. Zucker, Philadelphia, PA (US)

(21) Appl. No.: 14/851,610

(22) Filed: Sep. 11, 2015

(51) Int. Cl. A01K 29/00

(52) U.S. Cl. CPC A01K 29/00

(57) ABSTRACT

Systems, methods, and devices for singulating or separating insects from a collection of insects are described. In some embodiments, an insect singulating device includes a funnel having a first opening and a second opening, wherein the first opening is larger than the second opening and is configured to receive one or more organisms of the collection of organisms, and a roller assembly positioned proximate to the second opening of the funnel, wherein the roller assembly includes a first roller and second roller that are spaced apart to define an organism movement path between the first roller and the second roller.

### BACKGROUND

Drosophila is a genus of small flies commonly referred to as “fruit flies.” Their short reproductive cycle, small size, prolific breeding, and ease of care have led to widespread use as a model organism in biology. Fruit flies are frequently used in in genetics, developmental biology, and neuroscience research, as well as in the study of a multitude of diseases.

While some study relies exclusively examining large populations of flies, most research involves, at various times, the isolation or observation of individual organisms. For example, to create offspring of a particular genetic makeup, researchers will introduce males of one genotype with “virgin” females of another (that is, females that have not yet mated). In another example, the behavior of individual flies in a maze or when presented with certain stimuli might be observed and recorded.

Model organisms, such as fruit flies, are frequently received and maintained in vessels containing large populations of the insects. Typical techniques for separating the populations of insects into individual insects or small groups of insects (e.g., “singulating”) often include invasive procedures that may harm or otherwise modify the insects. A common approach involves anesthetizing the insects and then singulating them (manually or automatically).

For example, manual singulating may include moving anesthetized insects using fine-tipped forceps or other tool, which may physically injure the insects. Also, a commonly-used anesthetizing agent, carbon dioxide, can alter the organism's behavior and perception of taste and smell, and over-exposure can result in death.

### BRIEF DESCRIPTION OF THE DRAWINGS

Various embodiments are disclosed in the following detailed description and accompanying drawings.

FIG. 1 is a diagram illustrating an example insect singulating device.

FIG. 2A is a diagram illustrating a front view of a singulator assembly for an insect singulating device.

FIG. 2B is a diagram illustrating a back view of the singulator assembly for the insect singulating device.

FIG. 3 is a diagram illustrating an exploded view of the singulator assembly for the insect singulating device.

FIGS. 4A-4C are diagrams illustrating movement of an insect within a movement path established by the singulator assembly.

FIG. 5 is a block diagram illustrating a system for separating organisms from a collection of organisms.

FIGS. 6A-6C are diagrams illustrating cross-sectional views of various embodiments of the singulator assembly.

### DETAILED DESCRIPTION

### Overview

Systems, methods, and devices for separating, isolating, or singulating insects, such as fruit flies (e.g., Drosophila), from a collection of insects, are described. In some embodiments, an insect singulating device or apparatus includes components configured to isolate and remove one or more insects from a contained collection of insects without modifying or otherwise affecting the physical structure or behavior of the insects.

For example, the insect singulating device includes a container having a connection portion, and a singulator assembly. The singulator assembly includes a funnel having a first opening and a second opening, the first opening having a greater diameter than the second opening, and wherein the connection portion of the container covers the first opening of the funnel to define a chamber configured to contain the collection of Drosophila, a first roller proximate to the second opening of the funnel, a second roller proximate to the second opening of the funnel, wherein the first and second rollers rotate in opposite directions from each other in a plane substantially perpendicular to a plane defined by the first opening of the funnel, wherein the second roller is spaced apart from the first roller at the second opening to define a space between the first and second rollers that includes a channel extending from the second opening through the space, and wherein the first and second funnels are configured to move individual drosophila from the second opening through the channel, and a sensor configured to detect Drosophila within the channel in order to determine whether individual Drosophila pass through the channel. The device also includes an outlet operably connected to the singulator assembly, wherein the outlet is configured to receive Drosphila that have passed through the channel and remove the Drosophila from the singulator assembly.

In some embodiments, a method for isolating a selected number of flies from a larger collection of flies includes containing the collection of flies in a chamber having an opening, agitating the chamber to generally cause the flies to move toward the opening, rotating a first roller and a second roller, the second roller spaced apart from the first roller and located at the opening to define a space between the first and second rollers, receiving an individual fly from the collection through the opening, and moving the fly away from the chamber through a channel extending from the opening through the space between the first and second rollers when the fly contacts the first and/or second roller during rotation of the rollers.

In some embodiments, a singulator assembly or separator system, utilized for separating organisms from a collection of organisms, includes a funnel having a first opening and a second opening, wherein the first opening is larger than the second opening and configured to receive one or more organisms of the collection of organisms, and a roller assembly positioned proximate to the second opening of the funnel, wherein the roller assembly includes a first roller and second roller that are spaced apart to define an organism movement path between the first roller and the second roller.

Thus, in some embodiments, the systems, methods, and devices described herein facilitate the sequential separation of individual insects (e.g., fruit flies) from a collection of insects by urging flies to enter a singulation path established between two deformable rollers, which causes the flies to sequentially and/or individually exit a container housing the collection of flies and enter an output channel or other mechanism that transports the flies individually to various destinations, such as other containers, research devices, sorting mechanisms, and so on.

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and the equivalent.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Examples of the Insect Singulating Device

As described herein, non-invasive and/or non-affecting techniques for separating individual insects (or, small groups of insects) from a collection of insects would provide significant utility to researchers and other users of research insects, such as researchers of fruit flies.

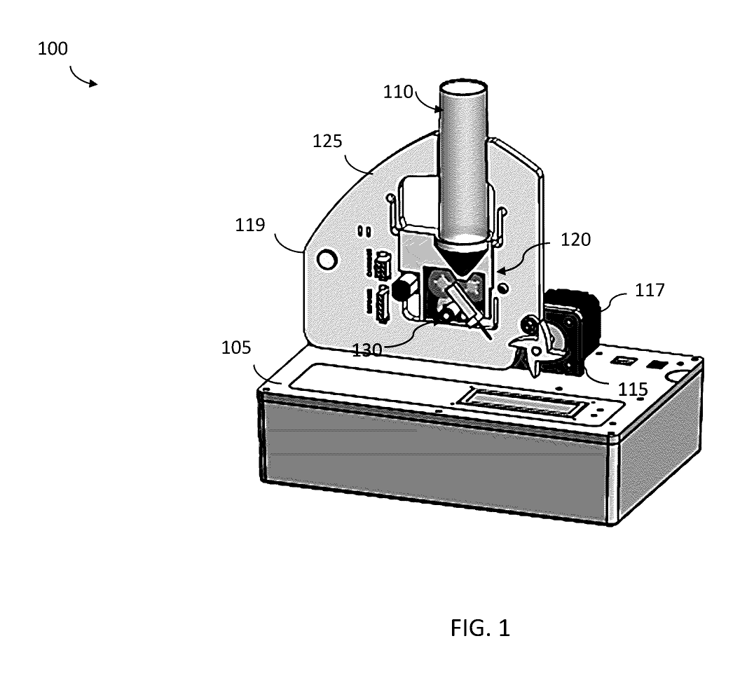

As described herein, systems and devices configured to separate insects from a collection of insects using non-invasive and non-affecting techniques are described. FIG. 1 is a diagram illustrating an example insect singulating device 100. The insect singulating device 100 includes a container 110 that houses a collection of insects, such as fruit flies. The container 110 may be open at one end, allowing insects to move out of the container when urged. The container 110 may also contain a food source, such as a mixture of yeast, cornmeal, and/or molasses, located at an end opposite to the open end.

The container 110 may be sized to contain many insects, such as 10, or 50, or 100, or more. As depicted, the container 110 may have a cylindrical shape, although the container 110 may be formed into other shapes or geometries, in order to fit various different sized or configured insect singulating devices.

The insect singulating device 100 also includes a singulator assembly 120, which is positioned proximate to the container 110, and coupled to the open end of the container 110. The singulator assembly 120 incudes various components configured and positioned to singulate or separate insects from the collection of insects in the container 110. Further details regarding the singulator assembly 120 are described herein.

An output 130, such as an output tube, valve, column, or passageway, is positioned proximate to the singulator assembly 120. The output 130 is coupled to the singulator assembly 120 such that the output 130 receives insects that pass through the singulator assembly 120. The output 130 may be connected or coupled to various tubes, such as a tube connected to a source of negative air pressure (not shown), which causes the insects to move out of the insect singulating device 100 to another location (such as another container at a research or observation chamber.

The insect singulating device 100 also includes a base 105, which may contain or support various control or computing circuitry or systems, including processors, memory, batteries, communication components, circuit boards, and so on. The base supports a housing 125, such as a housing 125 that is configured to position the container 110 proximate to and coupled with the singulator assembly 120 and/or configured to position the output 130 proximate to and coupled with the singulator assembly 120.

For example, as shown in FIG. 1, the housing 125 supports the container 110 such that the open end of the container 110 is positioned above the singulator assembly 120 and is coupled to the singulator assembly 120.

In some embodiments, the insect singulating device 100, via the housing 125, may provide a mechanism to urge or otherwise move insects within the container 110 towards the open end of the container 110. The housing 125 may include a fixed pivot 119, which facilitates a short, or relatively short, rotational movement of the housing 125 (and, the container 110), such as a tapping of the housing from a first, higher position, to a second, lower position.

In order to cause the housing to move (e.g., rotate), the insect singulating device 100 includes an agitator 115. The agitator 115 may be coupled to a motor 117, which rotates a gear having a plurality of teeth that engage with the housing 125, such that at least a first tooth of the gear lifts the housing 125 around the fixed pivot 119 while the tooth engages with the housing 125. This rotation causes the housing 125 to drop or tap after the first tooth ceases to engage with the housing 125, and, when repeated, causes a tapping or urging of the housing 125 and container 110.

Of course, the insect singulating device 100 may include other mechanisms for causing the housing 125 to move, and thus cause insects to move towards the open end of the container 110 and into the singulator assembly 120, such as mechanisms that shake, rotate, translate, vibrate, revolve, or otherwise move the container 110 in order to urge insects towards an end of the container 110. For example, the insect singulating device 100 may include an air pressure mechanism configured to cause insects to move towards the open end of the container 110 and/or a light mechanism configured to cause insects to move towards the open end of the container 110.

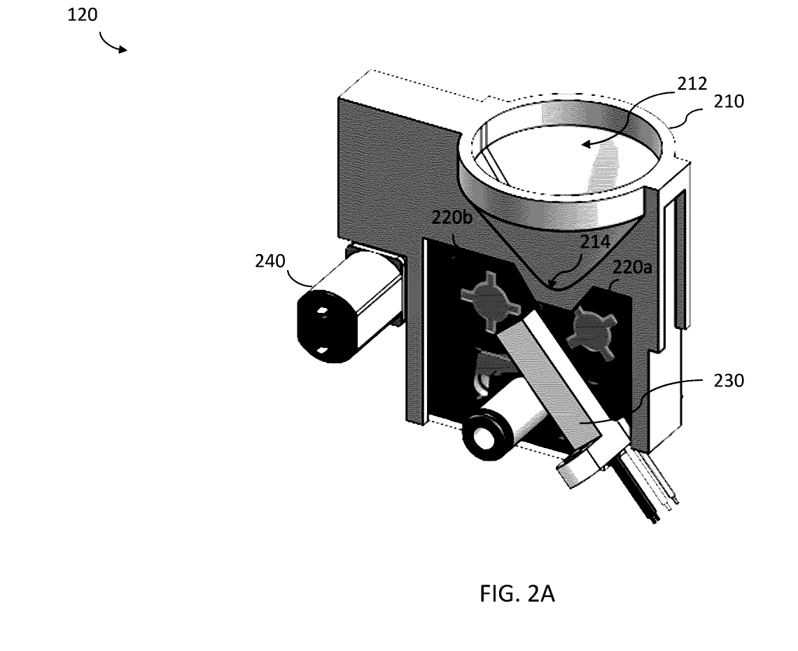

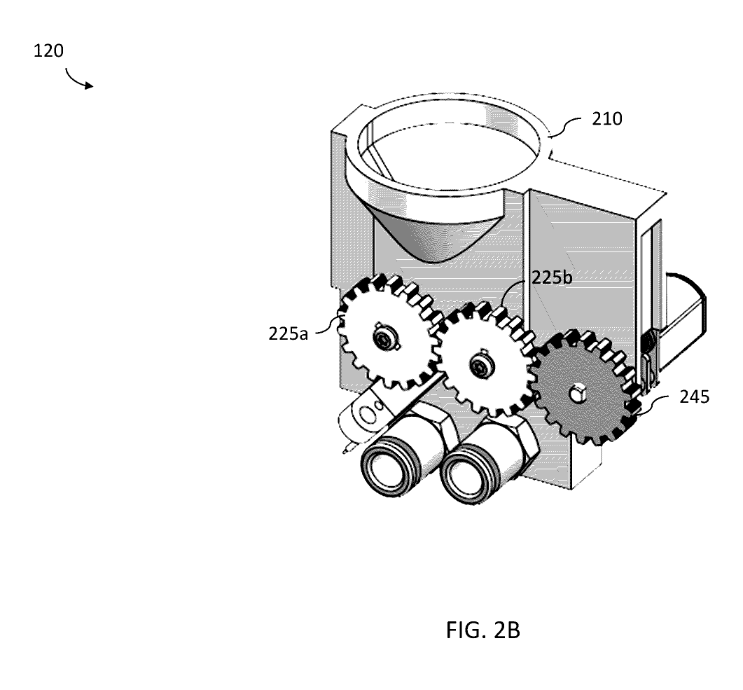

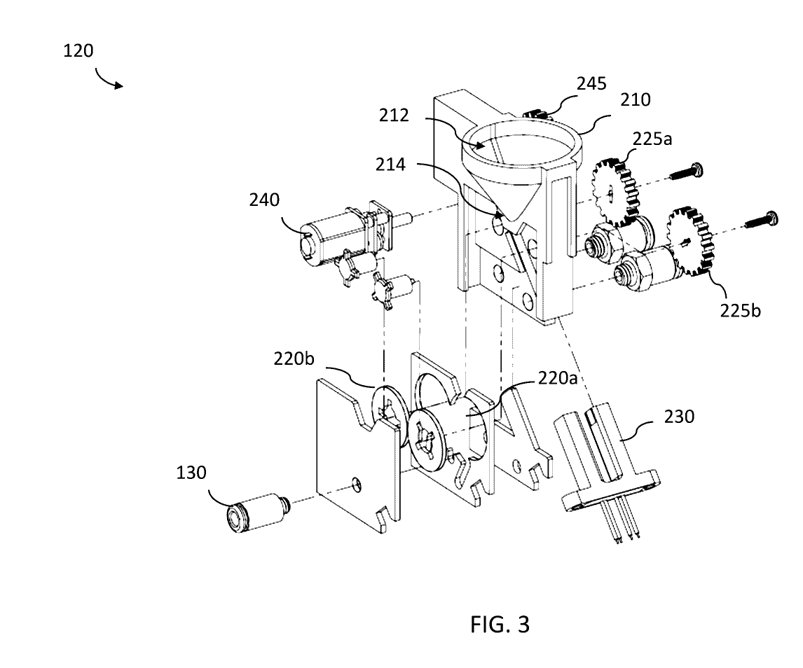

As described, the singulator assembly 120 includes various components that move insects in a sequential fashion out of the container 110. FIGS. 2A, 2B, and 3 illustrate the various components of the singulator assembly 120. The singulator assembly 120 includes a funnel 210, a pair of opposing rollers 220a and 220b positioned proximate to the funnel 210, and a sensing component 230 that detects objects (e.g., insects) within a space between the pair of opposing rollers 220a and 220b.

The funnel 210 has a first opening 212 coupled to the container 110, and a second opening 214, where the first opening has a greater diameter than the second opening, and wherein a connection portion, or open end, of the container 110 connects with the first opening 212 of the funnel 210 to define a chamber configured to contain the collection of insects.

As show in FIG. 2A, a first roller (e.g., roller 220a) is proximate to the second opening 214 of the funnel 210, and a second roller (e.g., roller 220b) is proximate to the second opening 214 of the funnel. The first and second rollers rotate in opposite directions from each other in a plane substantially perpendicular to a plane defined by the first opening 212 of the funnel 210, and away from the funnel 210. The second roller is spaced apart from the first roller at the second opening 214 to define a space between the first and second rollers that includes a channel extending from the second opening through the space. The first and second rollers are configured to move individual insects from the second opening through the channel, and to the output 130.

The rollers 220a and 220b are coupled to a motor 240 via a set of interlocking gears, such as gears 245, 225a, and 225b (shown in FIG. 3). For example, the motor 240 causes gear 245 to rotate in a clockwise direction, which causes gear 225b to rotate in a counterclockwise direction, which causes gear 225a to rotate in a clockwise direction.

In some embodiments, the rollers 220a and 220b are made of deformable foam or other deformable materials, and/or define a space between the first and second rollers that has a width that is less than a size of an individual insect of the collection of insects. In some embodiments, at least one of the rollers 220a or 220b includes teeth that project into the space between the first and second rollers 220a and 220b that are spaced apart to form a gap sized to contain an individual insect.

As described herein, the sensing component 230 may detect insects within the space established between the rollers 220a and 220b, such as within a channel between the second opening 214 of the funnel 210 and the outlet 130. The sensing component 230 may include and/or be a variety of different devices. In some embodiments, the sensing component 230 may be an electromechanical sensor that utilizes infrared, ultrasound, or other technologies to detect the presence of an insect within a space. In some embodiments, the sensing component 230 may be an image sensor or camera, which captured images of the space, such as images representative of an insect within the space and/or the space absent any insects.

A controller (described in more detail herein), may control operation of the insect singulating device 100 based on whether the sensing component 230 detects the presence of an insect within the space. For example, once the sensing component 230 detects one or more insects within the space, the controller may stop or otherwise modify the rotation of the rollers 220a, 220b, or otherwise modify operation of the device 100.

Thus, in some embodiments, the singulator assembly 120 may be a separator system for separating organisms from a collection of organisms, where the separator system includes a funnel having a first opening and a second opening, wherein the first opening is larger than the second opening and is configured to receive one or more organisms of the collection of organisms, and a roller assembly positioned proximate to the second opening of the funnel, wherein the roller assembly includes a first roller and second roller that are spaced apart to define an organism movement path between the first roller and the second roller.

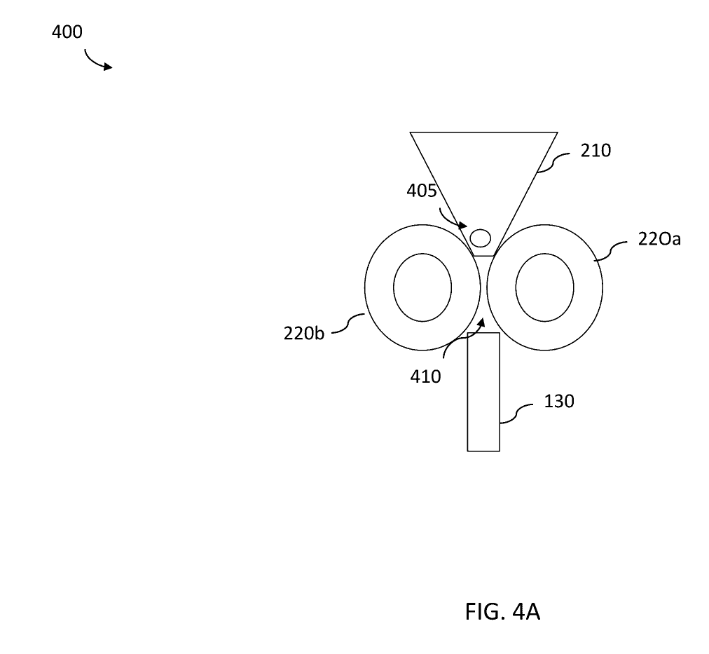

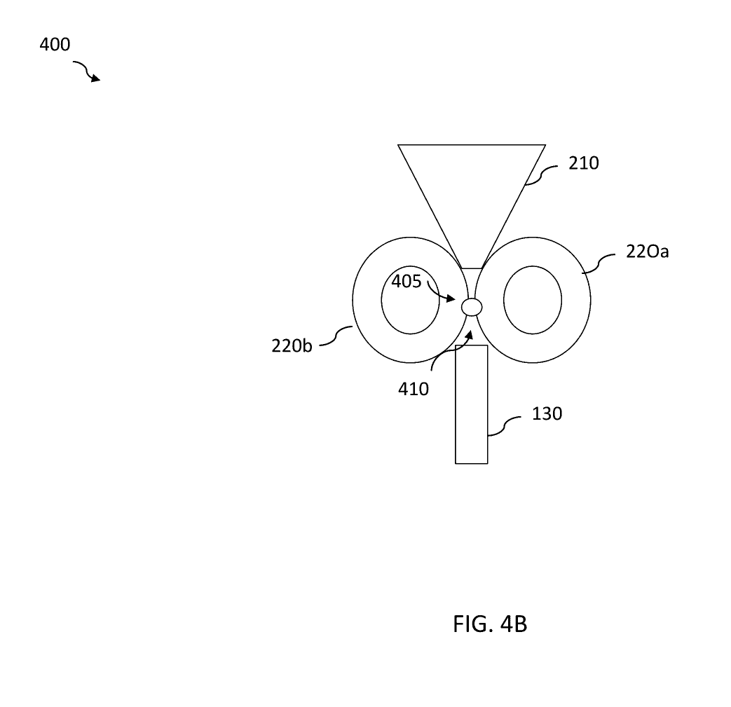

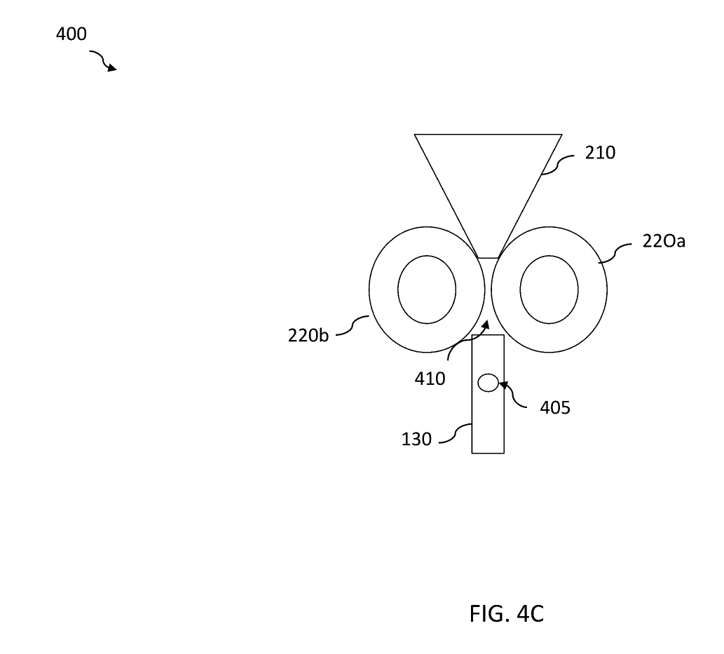

The organism movement path, therefore, may extend from the second opening of the funnel 214 to the outlet 130, between the first roller and the second roller, which rotate such that an organism located between the first roller and the second roller moves along the organism movement path. FIGS. 4A-4C are diagrams illustrating movement of an insect within a movement path established by the singulator assembly.

FIG. 4A depicts an insect (e.g., fruit fly 405) that is located within the funnel 210 near the second opening 214 of the funnel 210. As shown, a movement path 410 extends from the second opening 214 of the funnel 210 to the outlet 130, between the roller 220a and 220b.

In FIG. 4B, the two rollers 220a and 220b receive the individual fly 405 from the collection through the second opening 214 of the funnel 210, and rotate, moving the fly 405 away from the chamber through the movement path 410. As shown, the fly 405 contacts the rollers 220a and 220b while moving through the movement path 410, as the width of the movement path 410 is shorter than the size of the fly 405. However, the rollers 220a and 220b are made of a deformable material, and the fly is unaffected.

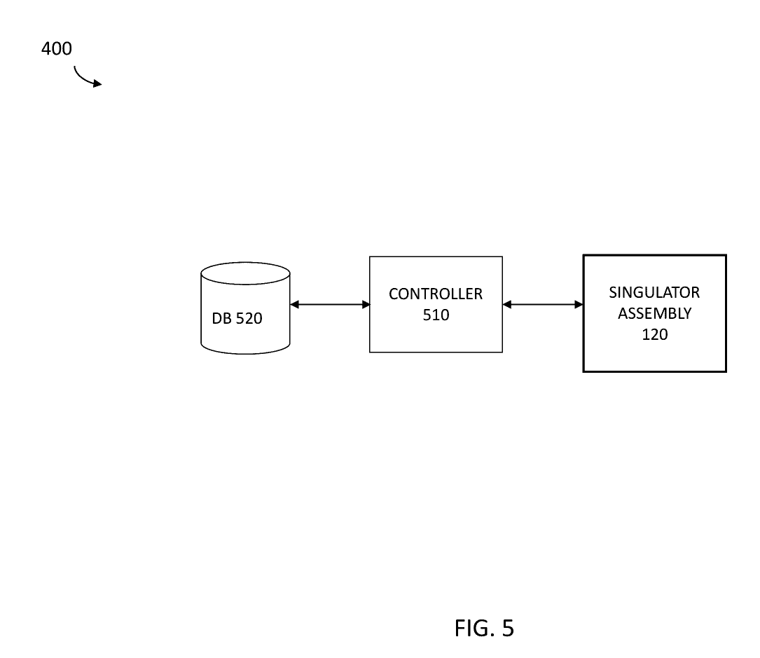

FIG. 4C depicts the fly 405 exiting the movement path 410 and enters the outlet 130. At this point, the sensing component 230 (not shown in FIG. 4C) detects the presence of the fly within the space. A controller determines that a certain number of flies (e.g., one or more) have moved through the channel based on the captured images of the channel, and stops or pauses the rotation of the rollers 220a and 220b, and/or the agitation of the chamber in response to the determination. FIG. 5 illustrates a controller 510 in communication with the singulator assembly 120.

The controller 510 communicates with the sensing component 230 and is configured to stop/pause the rollers 220a and 220b from rotating after a selected number of flies 405 are detected. For example, the sensing component 230 may send control signals to the controller 510, which determines the presence of an insect within the movement path 410 or the outlet 130 based on the content in the control signals. The controller 510, which may store information (e.g., information associated with a count of insects and/or various control instructions) in a database 520, determines the presence of an individual fly 405, and modifies operation of the singulator assembly 120 and/or the fly singulating device 100.

The controller 510 may be part of a computing system, such as a computing system stored within the base 105 and/or at a remote device (not shown), and include a processor that communicates with data or applications stored in memory of the device, which may include a combination of temporary and/or permanent storage, and both read-only and writable memory (random access memory or RAM), read-only memory (ROM), writable non-volatile memory such as FLASH memory, hard drives, floppy disks, SIM-based components, and so on. The memory may include various program components or modules, such as an operating system, and various applications, such as applications downloaded to the device.

The insect singulating device 100 may be adapted in a variety of different configurations, geometries, and/or functions. For example, the insect singulating device 100 may include multiple containers 110, multiple singulator assemblies 120, multiple outputs 130, and so on.

The singulator assembly 120 may include one, two, three, or more rollers, which may be positioned in a variety of ways. The rollers may have similar sizes, different sizes, and so on. For example, roller 220a may be one large roller, while roller 220b is two small stacked rollers.

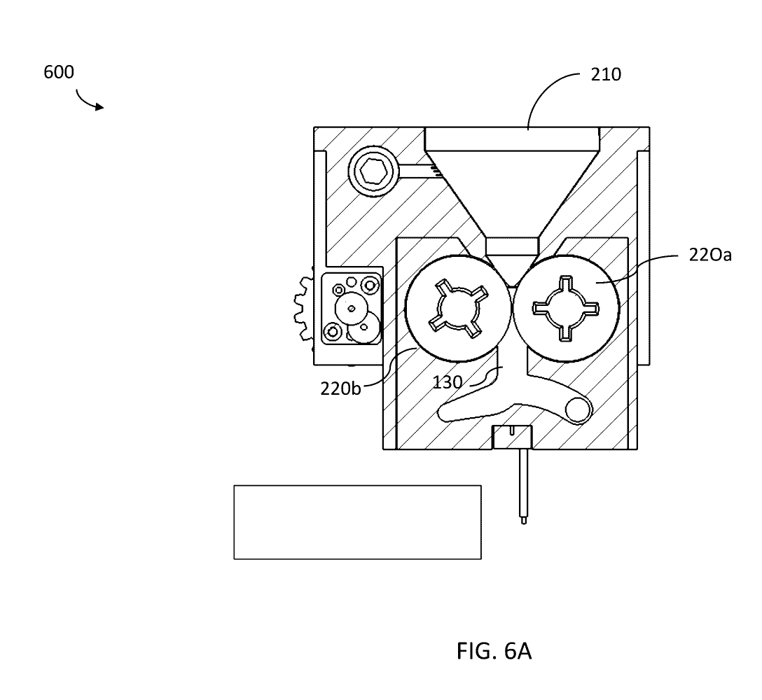

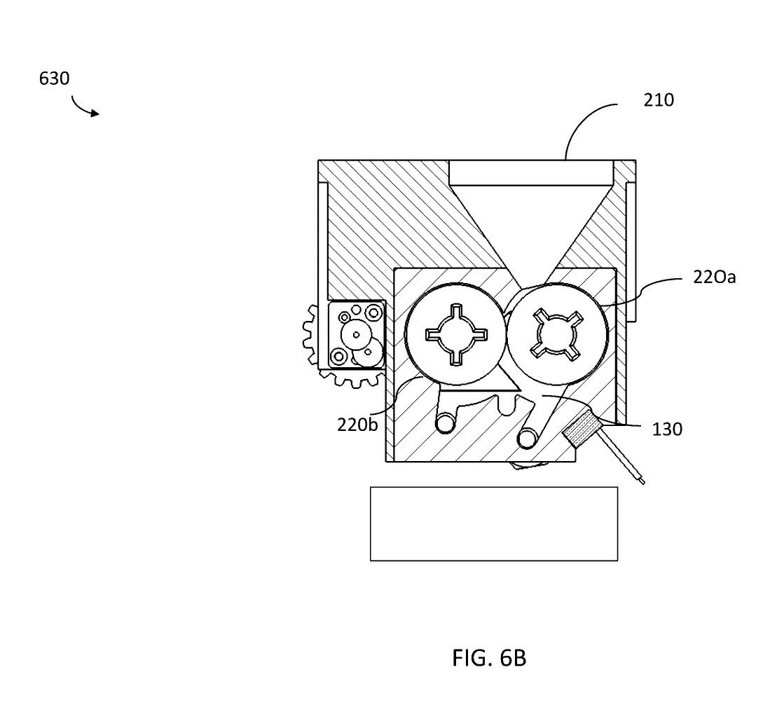

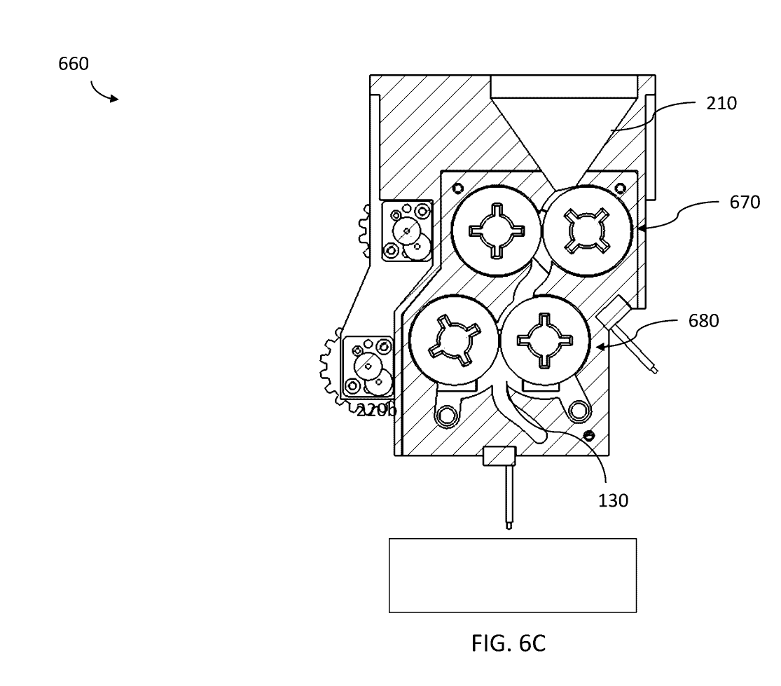

For example, FIG. 6A illustrates, in some embodiments, a singulator assembly 600 where the funnel 210 is positioned directly over or proximate to the outlet 130.

As another example, FIG. 6B illustrates, in some embodiments, a singulator assembly 630 where the funnel 210 is positioned closer to one of the rollers 220a, and where roller 220a touches roller 220. The funnel 210 is askew or otherwise at an angle from the outlet 130. Thus, a fly that travels out of the funnel may be more likely to make contact with a roller (e.g., roller 220a) as it travels through the movement path and towards the outlet 130.

As another example, FIG. 6C illustrates, in some embodiments, a singulator assembly 660 that includes a first set of rollers 670 positioned above or over a second set of rollers 680. Thus, the singulator assembly 660 may have a movement path that includes space between the first set of rollers 670, space between the second set of rollers 680, and/or any space between the sets of rollers 670, 680.

The singulator assembly 120, therefore, may include rollers, wheels, drums, gear, or rotating objects configured to capture or trap an insect within a movement path, and cause the insect to traverse the movement path without harming or otherwise affecting the insect. Therefore, in some embodiments, the insect singulating device 100 includes a singulator assembly 120 that removes and isolates individual insects from a collection of insects, without affecting or harming the insects during the singulation or singulating process.

### Conclusion

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It is to be understood that the phraseology and terminology employed herein is not to be construed as limiting and are for descriptive purpose only. It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

We claim:

1. A device for isolating individual Drosophila from a collection of Drosophila, the system comprising:
a container having a connection portion;
a singulator assembly, the singulator assembly including:
a funnel having a first opening and a second opening, the first opening having a greater diameter than the second opening, and wherein the connection portion of the container covers the first opening of the funnel to define a chamber configured to contain the collection of Drosophila;
a first roller proximate to the second opening of the funnel;
a second roller proximate to the second opening of the funnel,
wherein the first and second rollers rotate in opposite directions from each other in a plane substantially perpendicular to a plane defined by the first opening of the funnel,
wherein the second roller is spaced apart from the first roller at the second opening to define a space between the first and second rollers that includes a channel extending from the second opening through the space, and
wherein the first and second rollers are configured to move individual drosophila from the second opening through the channel; and
an object detector configured to detect Drosophila within the channel in order to determine whether individual Drosophila pass through the channel; and
an outlet operably connected to the singulator assembly, wherein the outlet is configured to receive Drosphila that have passed through the channel and remove those Drosophila from the singulator assembly.

2. The system of claim 2, further comprising:
a housing that includes the container and the singular assembly, wherein the housing includes a fixed pivot; and
an agitator configured to agitate the housing to advance Drosophila toward the second opening of the funnel, wherein the agitator includes a gear having a plurality of teeth that is configured to engage with the housing such that at least a first tooth of the gear lifts the housing around the fixed pivot while the tooth engages with the housing, which causes the housing to drop after the first tooth ceases to engage with the housing.

3. The system of claim 1, wherein the outlet is a tube connected to a source of negative air pressure.

4. The system of claim 1, wherein at least one of the rollers comprises teeth that project into the space between the first and second rollers, and wherein the teeth are spaced apart such that a single Drosophila fits between them.

5. The system of claim 1, wherein the first and second rollers are formed of deformable foam.

6. The system of claim 1, wherein the second roller is spaced apart from the first roller at the second opening to define a space between the first and second rollers that has a width that is less than a size of an individual Drosophila.

7. The system of claim 1, wherein the first roller contacts the second roller.

8. The system of claim 1, wherein the second opening of the funnel is positioned directly above the first roller.

9. The system of claim 1, further comprising:
a controller connected to the sensor and configured to stop the rollers from rotating after a selected number of Drosophila are detected by the object detector.

10. The system of claim 1, wherein the container is removably attached to the singulator assembly.

11. The system of claim 1, wherein the container includes a food source located opposite from the connection portion.

12. A method for isolating a selected number of flies from a larger collection of flies, the method comprising:
containing the collection of flies in a chamber having an opening;
agitating the chamber to generally cause the flies to move toward the opening;
rotating a first roller and a second roller, the second roller spaced apart from the first roller and located at the opening to define a space between the first and second rollers;
receiving an individual fly from the collection through the opening; and
moving the fly away from the chamber through a channel extending from the opening through the space between the first and second rollers when the fly contacts either the first roller or second roller during rotation of the rollers.

13. The method of claim 12, further comprising:
detecting flies within the channel;
determining a certain number of flies have moved through the channel based on the detection of flies within the channel; and
stopping the rotation of the first roller and the second roller and the agitation of the chamber in response to the determination.

14. The method of claim 12, further comprising:
capturing images of the channel;
determining the individual fly has moved through the channel based on the captured images of the channel.

15. The method of claim 12, wherein the first and second rollers rotate in opposite directions with respect to one another and away from the chamber, and wherein the space between the first and second rollers has a width that is smaller than a width of a fly.

16. A separator system for separating organisms from a collection of organisms, the system comprising:
a funnel having a first opening and a second opening, wherein the first opening is larger than the second opening and configured to receive one or more organisms of the collection of organisms; and
a roller assembly positioned proximate to the second opening of the funnel, wherein the roller assembly includes a first roller and second roller that are spaced apart to define an organism movement path between the first roller and the second roller.

17. The separator system of claim 16, further comprising:
an outlet positioned proximate to the roller assembly;
wherein the organism movement path extends from the second opening of the funnel to the outlet.

18. The separator system of claim 16, wherein the first roller and the second roller include a deformable material.

19. The separator system of claim 16, wherein a width of a portion of a space between the first roller and the second roller is smaller than a size of the organisms.

20. The separator system of claim 16, wherein the first roller and the second roller are configured to rotate such that an organism located between the first roller and the second roller moves along the organism movement path.
